(19) United States
(12) Patent Application Publication
(10) Pub. No.: US 2017/0176963 A1
(43) Pub. Date: Jun. 22, 2017

(54) METHOD FOR SETTING USER PREFERENCES

(71) Applicant: Carrier Corporation, Farmington, CT (US)

(72) Inventor: Santhosh Reddy Goli, Warangal (IN)

(21) Appl. No.: 15/385,074

(22) Filed: Dec. 20, 2016

(30) Foreign Application Priority Data
Dec. 21, 2015 (IN) 4205/DEL/2015

(51) Int. Cl. G05B 15/02; F24F 11/00; G07C 9/00

(52) U.S. Cl. CPC G05B 15/02; G07C 9/00007; F24F 11/006; F24F 2011/0068; F24F 2011/0063; F24F 2221/38

(57) ABSTRACT

A method for providing individualized control of a designated area within a building includes sensing a secure key of a portable device and identifying one or more preferred settings associated with the secure key. A signal is sent to at least one controllable device within the designated area to alter operation of the at least one controllable device to achieve the preferred settings associated with the secure key.

### PRIORITY

This application claims priority to Indian Patent Application No. 4205/DEL/2015, filed 21 Dec. 2015, and all the benefits accruing therefrom under 35 U.S.C. §119, the contents of which in its entirety are herein incorporated by reference.

### BACKGROUND

This disclosure relates generally to a system and method of setting user preferences, and more particularly, to automating the use of sensed data to select user preferred settings for an environmental condition.

Controllable devices located in a home, hotel, or other building are limited in their ability to be adjust automatically based on a user's identity and preferences. For example, buildings typically include a plurality of zones and one or more thermostats mounted within the building are configured to control the temperature within the plurality of zones. If a person within the building migrates between the plurality of zones, the person will need to continuously enter his or her preferred settings at the thermostat associated with each of the zones. Accordingly, there is a need to efficiently and automatically configure a thermostat with a user's preferences based on his or her identity when he or she enters one of the plurality of zones.

### SUMMARY

According to an embodiment, a method for providing individualized control of a designated area within a building includes sensing a secure key of a portable device and identifying one or more preferred settings associated with the secure key. A signal is sent to at least one controllable device within the designated area to alter operation of the at least one controllable device to achieve the preferred settings associated with the secure key.

In addition to one or more of the features described above, or as an alternative, in further embodiments sensing the secure key includes positioning the portable device near an identification unit within the designated portion of the building.

In addition to one or more of the features described above, or as an alternative, in further embodiments sensing the secure key includes moving the portable device into contact with an identification unit within the designated portion of the building.

In addition to one or more of the features described above, or as an alternative, in further embodiments said secure key is sensed by the identification unit via near field communication.

In addition to one or more of the features described above, or as an alternative, in further embodiments a controller operably coupled to the identification unit and the at least one controllable device is configured to generated the signal to the at least one controllable device in response to identifying the preferred settings associated with the secure key.

In addition to one or more of the features described above, or as an alternative, in further embodiments the one or more preferred settings associated with the secure key are stored within a database accessible by the controller.

In addition to one or more of the features described above, or as an alternative, in further embodiments the portable device is not in communication with the controller.

According to an embodiment, a method for providing individualized control of a designated area within a building includes sensing a secure key of an identification unit associated with a designated area of the building and communicating the secure key and one or more preferred settings to a controller. The secure key is authenticated and a signal is sent to at least one controllable device within the designated area to alter operation of the at least one controllable device to achieve the one or more preferred settings.

In addition to one or more of the features described above, or as an alternative, in further embodiments a portable device is configured to sense the secure key.

In addition to one or more of the features described above, or as an alternative, in further embodiments the portable device is configured to sense the secure key via near field communication.

In addition to one or more of the features described above, or as an alternative, in further embodiments the portable device includes an application within which the one or more preferred settings are stored.

In addition to one or more of the features described above, or as an alternative, in further embodiments the secure key and the one or more preferred settings are communicated to the controller by the portable device.

In addition to one or more of the features described above, or as an alternative, in further embodiments the at least one controllable device is only configured to communicate sensed information to the controller.

According to another embodiment, a system for providing individualized control of a designated area within a building includes at least one controllable device arranged within a designated area of the building and at least one identification unit associated with the designated area of the building. A controller provides a communication interface between the at least one controllable device and the at least one identification unit. A portable device is associated with a user's preferred settings for the at least one controllable device. The portable device is configured to communicate with the identification unit.

In addition to one or more of the features described above, or as an alternative, in further embodiments the controller is integrally formed with the at least one controllable device.

In addition to one or more of the features described above, or as an alternative, in further embodiments the at least one controllable device is a heating, ventilation, and air conditioning device.

### BRIEF DESCRIPTION OF THE DRAWINGS

The subject matter, which is regarded as the present disclosure, is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic diagram of a system for providing individualized control of at least one controllable device associated with a designated area of a building according to an embodiment; and

FIG. 2 is schematic diagram of another system for providing individualized control of at least one controllable device associated with a designated area of a building according to an embodiment.

The detailed description explains embodiments of the present disclosure, together with advantages and features, by way of example with reference to the drawings.

### DETAILED DESCRIPTION

The disclosure provided herein includes a system that, when implemented, provides individualized control of one or more devices based on the identity and location of the individual. Short range communication technologies may be leveraged not only to detect and identify a user, but also to initiate individualized control. While the present disclosure is described within the context of a system including one or more controllable heating, ventilation, and air conditioning (HVAC) devices, the system may be used to control not only temperature settings, but also preferences for an allowable humidity, air quality level, volatile organic compound level, and carbon dioxide level. In addition, it should be understood that the system 20 may be adapted to provide individualized control of any type of controllable device such as lighting, audio-visual systems, or security systems, to name a few non-limiting examples. In addition, it should be understood that the system may be used to provide control based on the occupancy schedule of the user, for a preset period of time, such as peak hours for example,

Referring now to the FIGS., various embodiments of a system 20 for providing individualized control are illustrated. In each embodiment the system 20 includes at least one controllable device 22. In the illustrated, non-limiting embodiment, the at least one controllable device 22 is an HVAC device, such as a thermostat, for example, configured to control a temperature within a designated area of a building 10. In other embodiments, the system 20 may include a plurality of substantially similar controllable devices 22, such as a plurality of HVAC devices, for example, arranged at various locations within one or more buildings 10. Alternatively, the plurality of controllable devices 22 may include a variety of types of controllable devices 22, for example, an HVAC device, a lighting device, and an audio-visual device, arranged within either the same designated area or different areas. The types of controllable devices 22 described herein are intended as examples only, and it should be understood that other types of controllable devices 22 are within the scope of the disclosure.

An identification unit 24 is located within and associated with one or more designated areas of the building 10. For example, in a system 20 configured for use in a building 10 having a plurality of rooms, each room may be its own designated area and include an identification unit 24 associated therewith. In some embodiments, a plurality of identification units 24 may be associated with a given designated area. Alternatively, or in addition, an identification unit 24 may be associated with a plurality of designated areas, such as adjacent areas within the building 10 for example.

One or more controllers 26 are configured to provide a communication interface between an identification unit 24 and the at least one controllable device 22. In one embodiment, the functionality of a controller 26 is integrated into the at least one controllable device 22; however embodiments where the controller 26 is remotely located from the controllable device 22 are also within the scope of the disclosure. The identification unit 24 may communicate with the controller 26 wirelessly, or through a hard wired connection. The controller 26 may be separate from the at least one controllable device 22. As a result, in embodiments where the system 20 includes a plurality of controllable devices 22, the controller 26 may be configured to communicate with more than one of the plurality of controllable devices 22. In other embodiments, a controller 26 may be integrally formed with each controllable device 22.

The system 20 additionally includes a portable device 28 configured to communicate with the identification unit 24, and in some embodiments, with the at least one controller 26. Examples of a portable device 28 include, but are not limited to, a computer, a tablet, a personal digital assistant (PDA), a smartphone, a cellular device with SMS capabilities, a key fob having a computer chip, a smart watch, a fitness band, another wearable device, a tag, a sticker or any other device configured to generate a signal. In one embodiment, the portable device 28 and identification unit 24 are configured to communicate via near field communication (NFC). However, any other type of communication enabled by the portable device 28 and the identification unit 24, such as Bluetooth, a local or public data network, radio frequency, a cellular network, or any other wireless or wired network for example, are also within the scope of the disclosure.

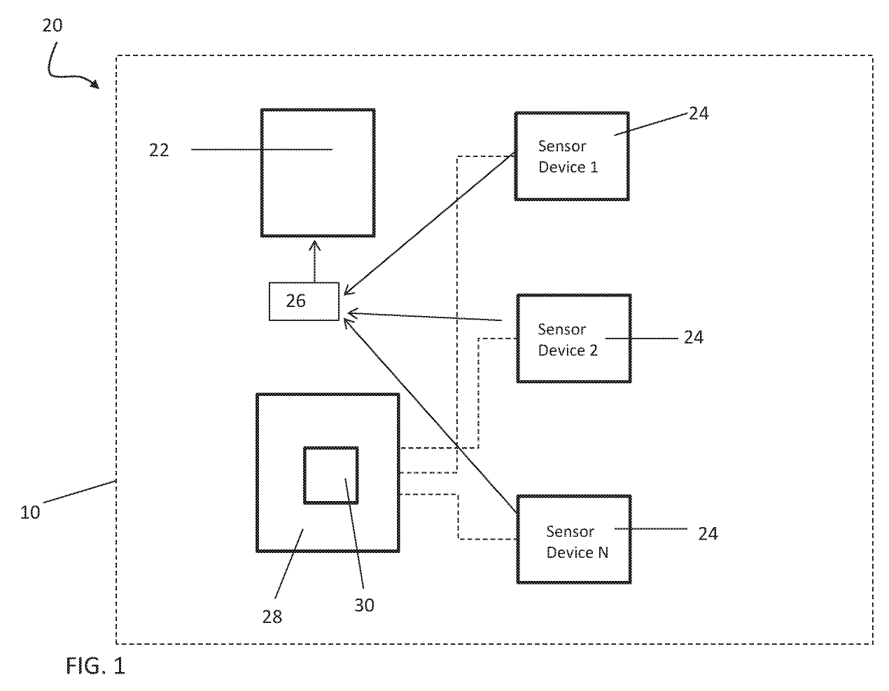

With reference now to the non-limiting embodiment of the system 20 illustrated in FIG. 1, the portable device 28 includes a passive or dynamic NFC tag configured to transmit a secure key 30 embedded therein. In such embodiments, the preferred settings of the user in possession of the portable device 28 have already been associated with the secure key 30 and stored within a database (not shown) accessible by the at least one controller 26. For example, upon receipt or initial activation of the portable device 28, the user may have been prompted to enter and store one or more preferences. The database may be stored within a local machine, the controllable device 22, the controller 26, or web storage media, such as the cloud for example. When the portable device 28 is located near an identification unit 24 or put in contact with the identification unit 24, the identification unit 24 is configured to read the secure key 30 and communicate the secure key 30 to the controller 26. In response, the controller 26 will access the database and based upon the identify of identification unit, will identify the preferences of the user associated with the secure key 30. These preferences will then be sent via a signal to the at least one controllable device 22 associated with the identification unit 24 to adjust the operation of the controllable device 22 to achieve the user's preferred settings.

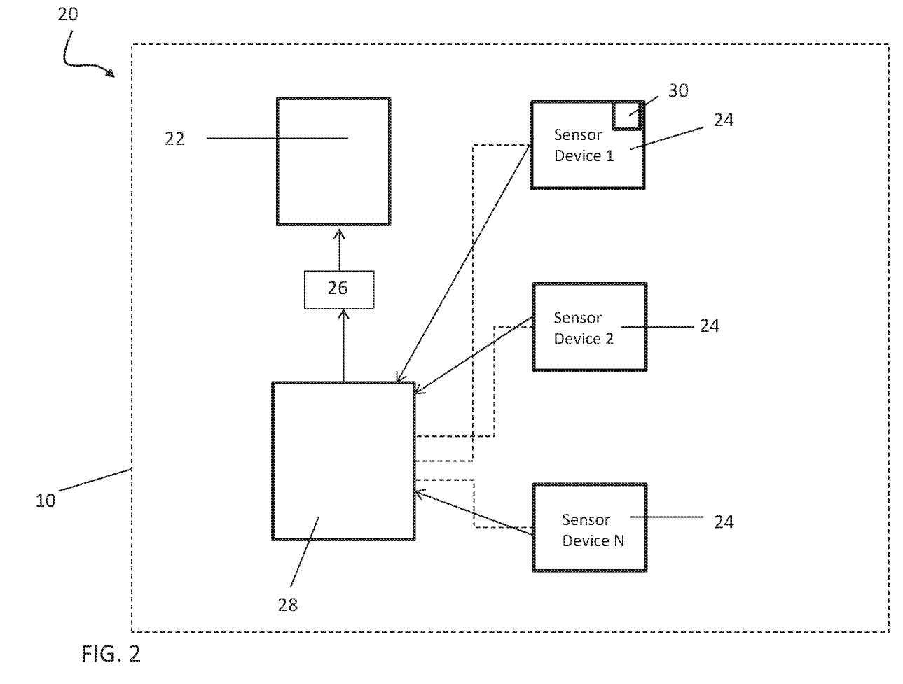

In an alternate embodiment of the system 20, illustrated in FIG. 2, the identification unit 24, not the portable device 28, includes a passive NFC tag configured to transmit a secure key 30 embedded therein. The identification unit 24 may also be able to transmit measured or sensed attributes, such as a current room temperature for example, to the controller 26. The portable device 28 is arranged in direct communication with the controller 26, via an Internet, wireless, wireless local area. network, or cellular connection. The portable device 28 additionally includes a program or application (“App”) that is operable not only to store the preferred settings of the user, but also to sense the secure key 30 of the identification unit 24.

To provide individualized control of the at least one controllable device 22 within a designated area, the portable device 28 is positioned near or in contact with an identification unit 24 in the designated area. In one embodiment, a user manually opens the corresponding app stored on the portable device 28 before contacting the identification unit 24 to read the secure key 30. However, in other embodiments, detection of the identification unit 24 may automatically initiate operation of the app and/or communication with the controller 26. The portable device 28 senses the secure key 30 stored within the identification unit 24 and then communicates both the secure key 30 and the preferred settings stored within the app to a controller 26. In response, the controller 26 will authenticate the secure key 30 and generate a signal to the at least one controllable device 22 within the designated area associated with the identification unit 24 to adjust the settings for the at least one controllable device 22 to the preferred settings of the user.

The system 20 described herein allows a user to easily personalize settings of one or more controllable devices 22 associated with a designated area of a building.

While the present disclosure has been particularly shown and described with reference to the exemplary embodiments as illustrated in the drawing, it will be recognized by those skilled in the art that various modifications may be made without departing from the scope of the present disclosure. Therefore, it is intended that the present disclosure not be limited to the particular embodiment(s) disclosed as, but that the disclosure will include all embodiments falling within the scope of the appended claims.

1. A method for providing individualized control of a designated area within a building, comprising:
sensing a secure key of a portable device;
identifying one or more preferred settings associated with the secure key; and
sending a signal to at least one controllable device within the designated area to alter operation of the at least one controllable device to achieve the preferred settings associated with the secure key.

2. The method according to claim 1, wherein sensing the secure key includes positioning the portable device near an identification unit within the designated portion of the building.

3. The method according to claim 1, wherein sensing the secure key includes moving the portable device into contact with an identification unit within the designated portion of the building.

4. The method according to claim 2, wherein said secure key is sensed by the identification unit via near field communication.

5. The method according to claim 1, wherein a controller operably coupled to the identification unit and the at least one controllable device is configured to generated the signal to the at least one controllable device in response to identifying the preferred settings associated with the secure key.

6. The method according to claim 5, wherein the one or more preferred settings associated with the secure key are stored within a database accessible by the controller.

7. The method according to claim 1, wherein the portable device is not in communication with the controller.

8. A method for providing individualized control of a designated area within a building, comprising:
sensing a secure key of an identification unit associated with a designated area of the building;
communicating the secure key and one or more preferred settings to a controller;
authenticating the secure key; and
sending a signal to at least one controllable device within the designated area to alter operation of the at least one controllable device to achieve the one or more preferred settings.

9. The method according to claim 8, wherein a portable device is configured to sense the secure key.

10. The method according to claim 9, wherein the portable device is configured to sense the secure key via near field communication.

11. The method according to claim 9, wherein the portable device includes an application within which the one or more preferred settings are stored.

12. The method according to claim 11, wherein the secure key and the one or more preferred settings are communicated to the controller by the portable device.

13. The method according to claim 8, wherein the at least one controllable device is only configured to communicate sensed information to the controller.

14. A system for providing individualized control of a designated area within a building, comprising:
at least one controllable device arranged within a designated area of the building;
at least one identification unit associated with the designated area of the building;
a controller operable as a communication interface between the at least one controllable device and the at least one identification unit; and
a portable device associated with a user's preferred settings for the at least one controllable device, the portable device being configured to communicate with the identification unit.

15. The system according to claim 14, wherein the controller is integrally formed with the at least one controllable device.

16. The system according to claim 14, wherein the at least one controllable device is a heating, ventilation, and air conditioning device.
